(19) United States
(12) Patent Application Publication
(10) Pub. No.: US 2019/0093976 A1
(43) Pub. Date: Mar. 28, 2019

(54) Adjustable Bipod

(71) Applicant: Timothy Dean Power, Elko, NV (US)

(72) Inventor: Timothy Dean Power, Elko, NV (US)

(21) Appl. No.: 16/145,181

(22) Filed: Sep. 28, 2018

Related U.S. Application Data
(60) Provisional application No. 62/563,951, filed on Sep. 27, 2017.

(51) Int. Cl. F41A 23/10; F41C 23/16; F16F 9/02; F16F 9/34

(52) U.S. Cl. CPC F41A 23/10; F16F 9/34; F16F 9/0218; F41C 23/16

(57) ABSTRACT

An adjustable bipod uses a gas spring to and pivotally attached pedals to manually adjust the height of the bipod legs on varying terrains to optimize device positioning.

### CROSS-REFERENCE TO RELATED APPLICATION

This application claims priority to U.S. Provisional Application No. 62/563,951 filed on Sep. 27, 2017, the disclosure of which, including any materials incorporated by reference therein, is incorporated herein by reference in its entirety.

### TECHNICAL FIELD

The present invention relates generally to a rifle accessory. More particularly, the present invention concerns an adjustable bipod system.

### BACKGROUND

Bipods, two-legged stabilization attachments for firearms, generally require a user to manually adjust each leg to achieve the proper height. Doing so takes time. Additionally, traditional bipod settings utilize intervals, which means a user cannot set the bipod to a height in-between the intervals. Furthermore, adjusting a traditional bipod generally requires the shooter to look away from the target and visually focus on the bipod. As such, traditional bipods can jeopardize the success of the shooter's agenda. What is needed therefore is an infinitely adjustable bipod system that can be operated while the shooter is looking through sights, a scope, or down the barrel on a target.

Attempts have been made, although unsuccessfully, to solve this problem. One illustrative attempt can be seen with respect to U.S. Pat. No. 7,954,272, which generally discloses an adjustable bipod system. While this disclosure provides for comprehensive bipod capabilities, its ring-shaped intermittent levels give it limited adjustability settings.

Another attempt to meet this need can be seen with respect to U.S. Patent Application Publication No. 2009/0038200, which generally discloses an extendable bipod having prearranged height settings. While this disclosure does provide for an easily adjusted bipod, its interval-based height adjustment leaves it without certain height settings.

Another attempt can be seen with respect to U.S. Pat. No. 7,111,424, which generally discloses a firearm fore grip having a built-in bipod. While this disclosure does certainly provide for versatility and the convenience of an ever-present bipod, its lack of sophisticated level settings limits its utility.

As can be seen, various attempts have been made to solve the problems which may be found in the related art but have been unsuccessful. A need exists for a new adjustable bipod system to avoid the challenges and problems with the prior art.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a bipod, platform, and so forth are herein meant to include or encompass all equivalents for such elements. For example, in addition to a “bipod,” any item sufficiently sturdy to provide support or stability to an attached device, such as a weapon or other device that requires stabilization, is also contemplated by the present invention. Such equivalents are contemplated for each element named in its particular herein.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for shooting a firearm using a bipod. The general purpose of the present invention, which shall be described subsequently in greater detail, is to enable a user to set up their bipod to exactly the desired level or height using one hand, if desired. The features of the invention are believed to be novel and to have been particularly pointed out and distinctly claimed in the concluding portion of the specification. These and other features, aspects, and advantages of the present invention will become better understood with reference to the following drawing and detailed description.

The features of the invention which are believed to be novel are particularly pointed out and distinctly claimed in the concluding portion of the specification. By way of non-limiting example, the present invention provides a novel solution for shooting a firearm using a bipod. These and other features, aspects, and advantages of the present invention will become better understood with reference to the following drawings and detailed description.

The present invention comprises an adjustable bipod system. In some embodiments, the present invention provides for a system wherein gas springs or gas charged cylinders provide the adjustment and stabilization means in an adjustable bipod system. More specifically, in some embodiments, the present invention may comprise a rifle bipod support system that utilizes gas springs to raise and lower the legs through one or more valves (“valving”) in the gas spring. The valving can be actuated using mechanical levers or buttons or remote mounted electrical buttons depending on the application. The valves are comprised of an open electric switch running in through the top member of each leg housing. When the switch is actuated (pushed), power is sent to the solenoids which will electromagnetically open the gas spring valve. When the button is release or when the circuit is broken, the solenoid ceases to have power and the spring valve closes, locking the leg into place. The buttons or levers control the gas spring valve to either raise or lower individual legs to accommodate adjustment and locking capability infinitely along the stroke of the gas spring shaft. This feature allows the user to keep eyes on target while leveling the rifle, increasing the speed and stability of the shooter.

In some embodiments, the present invention provides for the adjustment of support equipment, rifle bipods, tripods and mono pods with the push of a button or lever. This allows the user convenient one hand adjustment and locking capability along the entire stroke of gas spring. In the case of a rifle bipod a rocker switch mounted in a convenient location on the fore end, one on each side, may provide the signal (electronic) to the gas spring valve to raise or lower each leg individually. When the button is released, the leg locks in place. The mechanical applications will use mechanical buttons or levers/linkage to actuate the gas spring valve. The use of multi stage locking gas springs will increase the range of adjustably. In the event of needing more length then what can be engineered into a locking gas spring a mechanical extension can be attached to the lower leg(s) that can also be provided.

In some embodiments, the present invention works by simply utilizing lockable gas springs for the legs of bipods, tripods, mono pods. The user can push a button or lever that controls the flow of pressurized gas to raise or lower each leg and automatically lock leg in place when button released. On units that can benefit from remote control the legs will be controlled by electronic means and the units that require mechanical control will have mechanical levers or buttons.

The unique features of this product may provide the following benefits for consumers everywhere: it may provide longer range of adjustment, improved and near infinite locking capability along the stroke of the gas spring rod, faster target acquisitions, solid user positions, can operate quickly and conveniently, and can be operated and controlled with one hand.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

### BRIEF DESCRIPTION OF THE DRAWINGS

These and other features, aspects and advantages of the present invention will become better understood with regard to the following description, appended claims, and accompanying figures where:

FIG. 1 shows a front perspective view of an adjustable bipod.

FIG. 2 shows an enlarged perspective view of an adjustable bipod in use in accordance with an embodiment of the invention.

FIG. 3 shows a closed view of an adjustable bipod in accordance with an embodiment of the invention.

FIG. 4 shows a perspective view of an adjustable bipod in accordance with an alternative embodiment of the invention.

FIG. 5 shows a side perspective view of an adjustable bipod in use in accordance with an alternative embodiment of the invention.

FIG. 6 shows a closed view of an adjustable bipod in accordance with an alternative embodiment of the invention.

FIG. 7 shows a cross section of an adjustable bipod leg in accordance with an embodiment of the invention.

### DETAILED DESCRIPTION

The present invention overcomes the limitations of the prior art by providing a new and more effective stabilizing bipod for shooting firearms.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

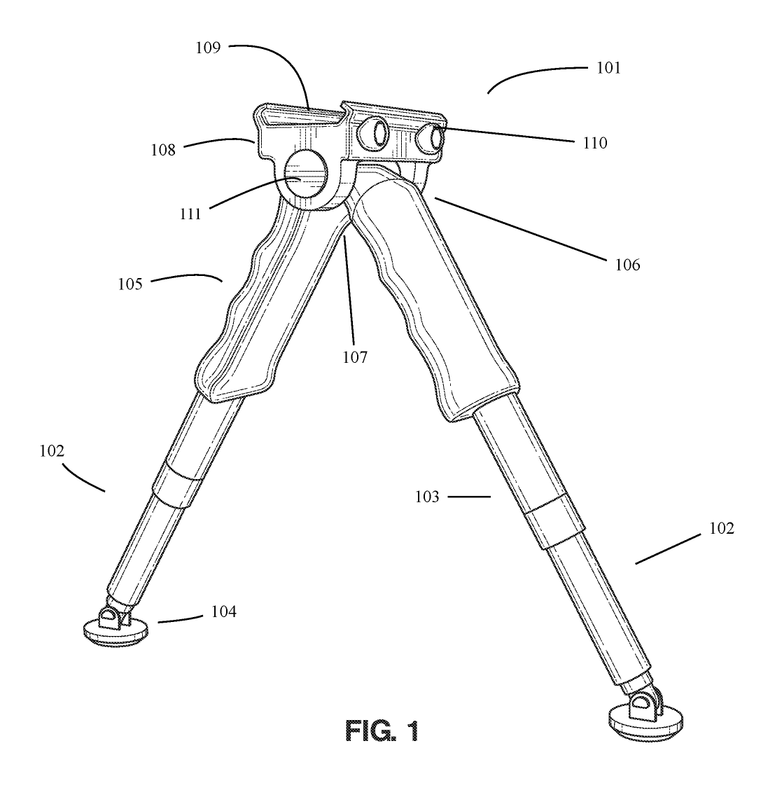

Turning attention to FIG. 1, a front perspective view of an adjustable bipod in accordance with an embodiment of the invention is shown. In the embodiment depicted, a viewer may perceive adjustable bipod 101, leg housings 102, that may be collapsed and adjusted 103, swivel feet 104, foregrips 105, and resting platform 106.

As may be appreciated by those of skill in the art, while two leg housings 102 are shown in FIG. 1, embodiments with three or more leg housings 102 are also contemplated. The leg housings 102 may be comprised of any material known in the art, such as but not limited to metal or plastic. In some embodiments, one or more leg housing 102 may provide for one or more hinges at the base of the leg housing 102 that allow for the foot pad to swivel 104, allowing for a sturdier positioning on uneven terrain.

In some embodiments, the leg housings 102 may be adjusted or collapsed 103, allowing for more sturdy positioning on uneven terrain or for ease of transport. Moreover, while generally shown as at even lengths, the orientation of one or more leg housings 102, in some embodiments, may be changed to accommodate for uneven terrain. Although not pictured in FIG. 1, one or more leg housings 102 may provide for an internal gas spring. A viewer may perceive that the leg housing 102 has two varying circumferences to accommodate for the gas spring cylinder and piston rod (not shown).

The top member 106 of each the leg housing 102 connect through a movable hinge 107. The movable hinge 107 is controlled and connected to the resting platform 108. The platform 108 comprises of a flat member 109 with a right and left side 110 that extends at least ½ inch from the base of the flat member 109. The platform 108 may be of any material with sufficient strength to withstand the weight of a heavy object, such as but not limited to metal, wood, or plastic. A viewer may observe that the right and left sides 110 are slightly curved to allow for a more secure holding of a fire arm on the platform 108.

In a preferred embodiment of the present invention, the adjustable bipod 101 utilizes gas springs to raise and lower the leg housings through one or more valves (not shown) in the gas spring (not shown). The valves (not shown) are comprised of an open electric switch running in through the top member of each leg housing 102. The valves are actuated using mechanical levers or buttons or remote mounted electrical buttons 111. When the electrical button 111 is actuated (pushed), power is sent to the solenoids which will electromagnetically open the gas spring valve. The power circuit is broken when the electrical button 111 is released.

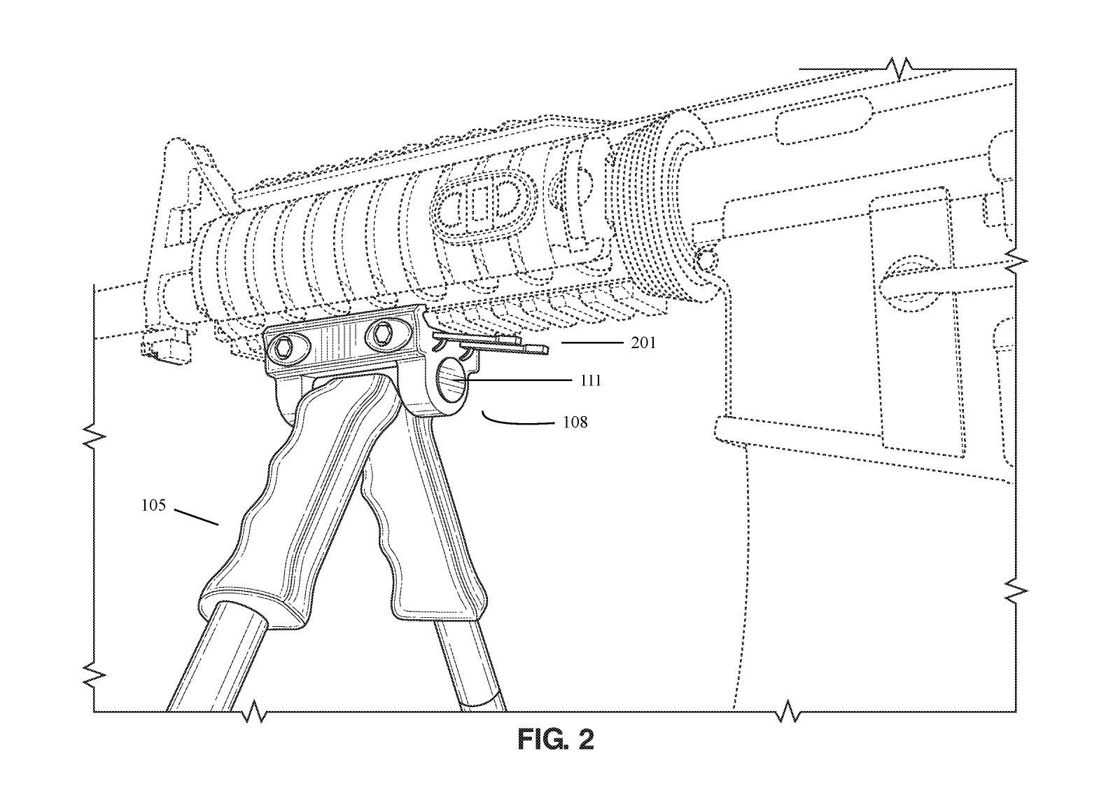

With respect to FIG. 2, an enlarged perspective view of an adjustable bipod in use in accordance with an embodiment of the invention is shown. In the embodiment depicted, a viewer may perceive adjustable bipod 101, foregrips 105, and platform 108.

FIG. 2 serves to show generally the adjustable bipod 101 in use. In FIG. 2, a user may generally see how a fire arm may rest on the platform 108 where the body of the fire arm extends laterally across the platform and its weight is supported fully by the platform 108 and the leg housings 102.

FIG. 2 also serves to illustrate the functionality of the platform 108. In the embodiment depicted, the platform 108 may be adjusted on the y-axis by maneuvering the levers 201 located on the anterior of the platform 108.

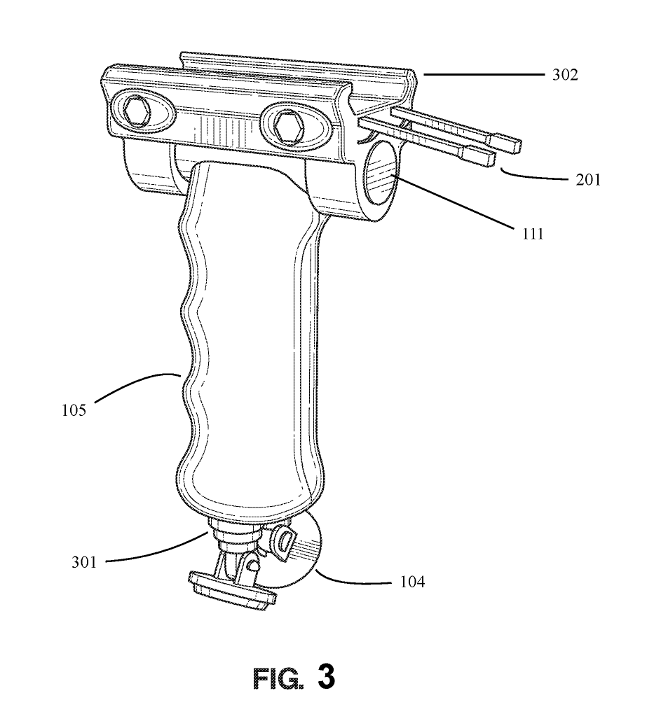

With regards to FIG. 3, a closed view of an adjustable bipod in accordance with an embodiment of the invention is shown. In the embodiment depicted, a viewer may perceive an adjustable bipod 101, in a closed position where the foregrips 105 are aligned and the leg housings 102 are collapsed within themselves having the housing edges 301 extending from the foregrips 105 and the swivel feet 104 connected thereon. A viewer may perceive that the lower member of the leg housings 102 collapses into the upper member of the leg housing 102 as the piston rod collapses and fits into the cylinder (not shown).

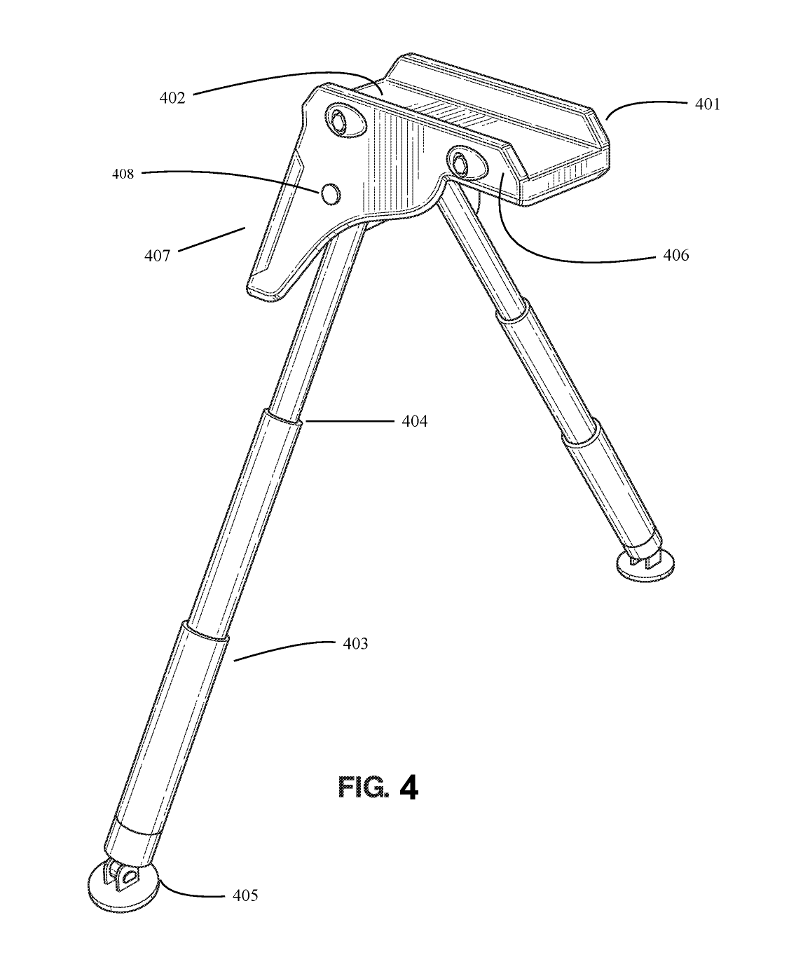

Turning attention to FIG. 4, a perspective view of an adjustable bipod in accordance with an alternative embodiment of the invention is shown. In the embodiment depicted, a viewer may perceive an adjustable bipod 401, leg housings 403, that may be collapsed and adjusted 404, swivel feet 405, and a resting platform 402. FIG. 4 serves to show alternative embodiments of the present invention. A viewer may perceive that the leg housings 403 are configured to collapse from the top down, rather than from the bottom up. A viewer may also perceive that the resting platform 402 has perpendicular sides 406 extending from the base of the platform. A viewer may also perceive an extension 407 from the base of the platform that assists in balancing a fire arm on the platform 401 and tilting the platform upwards or downwards to adjust the positioning of the fire arm for better aim positioning.

In a preferred embodiment of the present invention, the adjustable bipod 401 utilizes gas springs to raise and lower the leg housings 403 through one or more valves (not shown) in the gas spring (not shown). The valves (not shown) are comprised of an open electric switch running in through the top member of each leg housing 403. The valves are actuated using mechanical levers or buttons or remote mounted electrical buttons 408. When the electrical button 408 is actuated (pushed), power is sent to the solenoids which will electromagnetically open the gas spring valve. The power circuit is broken when the electrical button 408 is released.

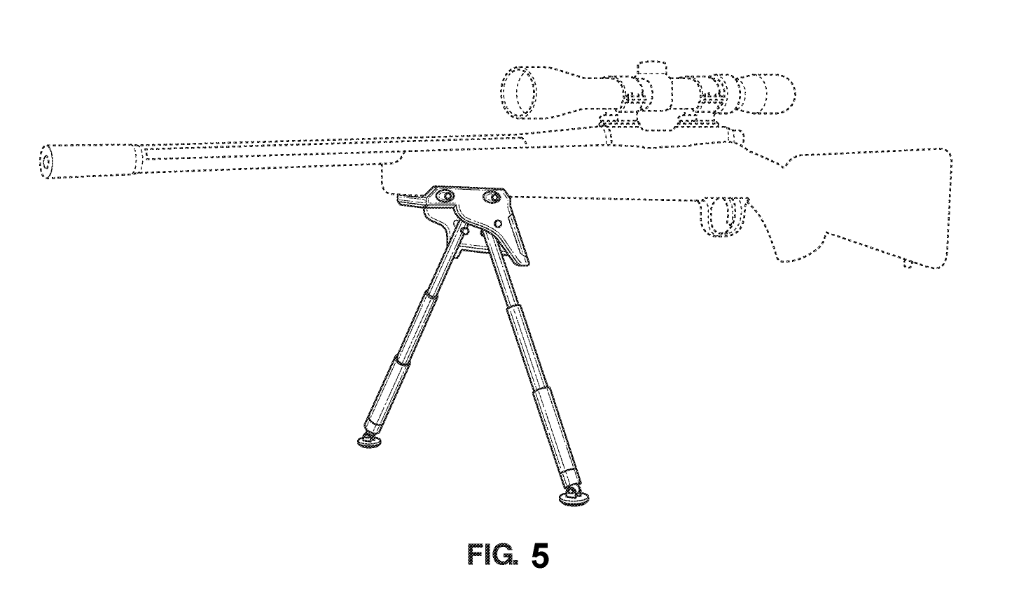

FIG. 5 serves to show generally the adjustable bipod 401 in use. In FIG. 2, a user may generally see how a fire arm may rest on the platform 402 where the body of the fire arm extends laterally across the across the platform and its weight is supported fully by the platform 108 and the leg housings 102.

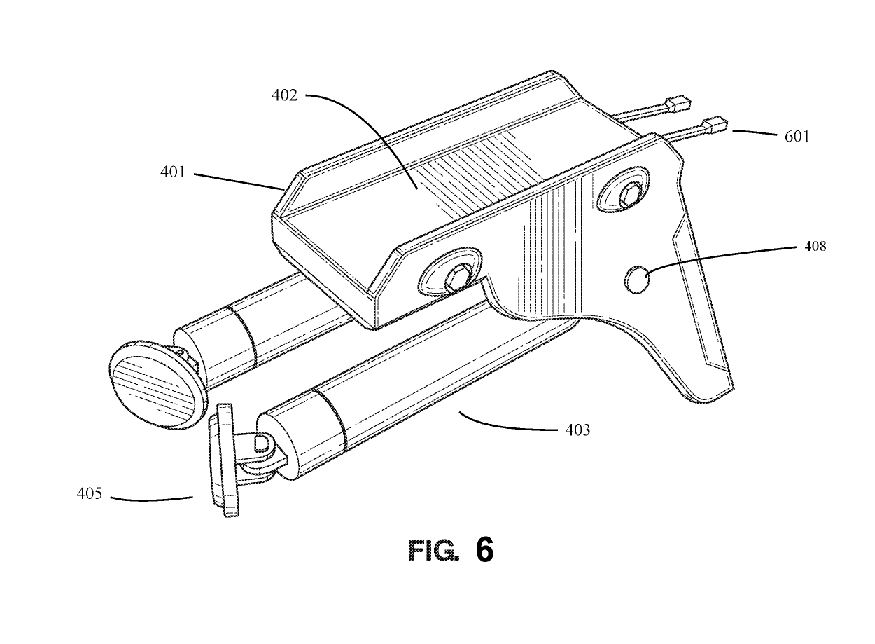

With regards to FIG. 6, a closed view of an adjustable bipod in accordance with an embodiment of the invention is shown. In the embodiment depicted, a viewer may perceive an adjustable bipod 401, in a closed position where the leg housings 403 are collapsed within themselves. A viewer may perceive that the upper member of the leg housings 404 collapses into the lower member of the leg housing 403 as the piston rod collapses and fits into the cylinder (not shown).

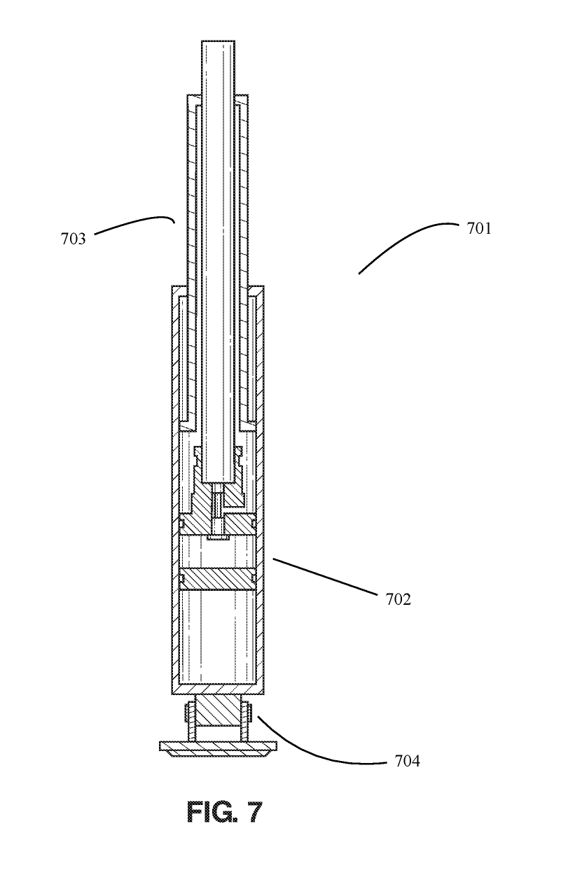

FIG. 7 depicts a cross section of a gas spring 701 which is located in the leg housing 102, 403 in both of the preferred and alternative embodiments of the present invention. A viewer may perceive that the housings for the cylinder 702 and the piston rod 703 serve to function as the leg housings 102, 403 in both of the preferred and alternative embodiments of the present invention. A viewer may also perceive that the swivel leg 704 is attached to the bottom member of the gas spring 701 and leg housing 102, 403 in both of the preferred and alternative embodiments of the present invention by means of a rotating hinge.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the present invention generally described herein has been disclosed in connection with a number of embodiments shown and described in detail, various modifications should be readily apparent to those of skill in the art.

What is claimed is:

1. An adjustable bipod for stabilizing a device, comprising
a platform configured for attachment to a device, the platform including a length extending from a proximal end and a distal end;
a first leg housing having an upper end pivotally coupled to the platform and a lower end pivotally coupled to a stabilizing pedal;
a second leg housing having an upper end pivotally coupled to the platform and a lower end pivotally coupled to a stabilizing pedal.

2. The apparatus of claim 1, where the platform comprises of a manual positioning member to causing the platform to pivot in an upward and downward direction within at least a 90-degree range.

3. The apparatus of claim 1, where the upper end of the first leg housing has a foregrip.

4. The apparatus of claim 1, where the upper end of the second leg housing has a foregrip.

5. An adjustable bipod for stabilizing a device, comprising
a platform configured for attachment to a device, the platform including a length extending from a proximal end and a distal end;
a first leg housing having an upper end pivotally coupled to the platform and a lower end pivotally coupled to a stabilizing pedal;
a second leg housing having an upper end pivotally coupled to the platform and a lower end pivotally coupled to a stabilizing pedal.

6. The apparatus of claim 5, where the first leg housing comprises of an internal gas spring with having all components necessary inclusive of a cylinder, gas component, piston rod, piston, sealing, and valve.

7. The apparatus of claim 5, where the second leg housing comprises of an internal gas spring with having all components necessary inclusive of a cylinder, gas component, piston rod, piston, sealing, and valve.

8. The apparatus of claim 6, where the piston rod portion of the first leg housing may be lockably compressed into the cylinder.

9. The apparatus of claim 7, where the piston rod of the second leg housing may be lockably compressed into the cylinder.

10. The apparatus of claim 5, where gas spring valves are electronically coupled to the platform, and comprise of at least actuator and at least one solenoid.
